(19) United States
(12) Patent Application Publication
(10) Pub. No.: US 2013/0052366 A1
(43) Pub. Date: Feb. 28, 2013

(54) NANO-SEEDING VIA DUAL SURFACE MODIFICATION OF ALKYL MONOLAYER FOR SITE-CONTROLLED ELECTROLESS METALLIZATION

(71) Applicants: Giin-Shan Chen, Taichung (TW); Sung-Te Chen, Taichung (TW); Yu-Lin Lu, Taichung (TW)

(72) Inventors: Giin-Shan Chen, Taichung (TW); Sung-Te Chen, Taichung (TW); Yu-Lin Lu, Taichung (TW)

(21) Appl. No.: 13/216,299

(22) Filed: Aug. 24, 2011

(51) Int. Cl. B05D 5/00; B05D 3/10

(52) U.S. Cl. 427/535

(57) ABSTRACT

Self-assembled-monolayer grafted seeding and electroless plating processes for patterning of metal-alloy thin films, comprising the steps of treating the surface of the substrate by organic species, covering the organic species-SAM coated surface of dielectric substrate with a template, treating the surface by vacuum plasma, immersing the substrate into an aqueous solution, removing the hydrogen from the surface of the substrate, immersing the negatively charged dielectric surface into an aqueous metal salt solutions for adsorbing metal ions, reducing the positively charged metallic cations into neutral metal particles which act as catalysts by a reducing agent, and immersing the dielectric substrate into an electroless-plating solution for deposition of metal and metal-alloy thin film patterns.

### FIELD OF INVENTION

This invention relates to novel concepts of fabricating nanostructured metallization patterns on dielectric layers by using plasma-patterned self-assembled monolayers (SAMs), in conjunction with a novel aqueous seeding and electroless process, which comprises of selected plasma modification, aqueous solution treatment on plasma-exposed regions, cation adsorption, cation reduction and selected electroless plating. This invention provides method to produce patterns of ultrathin (minimum thickness of 10 nm or less) metal-alloy films selectively fabricated on dielectric layers (e.g. silicon dioxide).

### BACKGROUND OF THE INVENTION

Since the development of the damascence process in 1997, copper has become the “metal of choice” for the incoming sub-45-nm interconnect technology, offering low RC delay, low power consumption and good migration resistance. As dry etching of copper is problematic, an example of one possible process sequence involving lithography for the damascence process is created, comprising the steps of deposition of copper by electrochemical plating onto high aspect-ratio, narrow trenches and holes; planarization of the embedded Cu-interconnect by chemical mechanical polish (CMP) instead of etching.

However, copper suffers from several critical problems: (1) weak adhesion of copper to dielectrics and polymers; (2) diffusion of wiring-leveled copper into dielectrics, deteriorating the electrical properties and reliability; (3) if used as contact plug, diffusion into and chemically reaction with the bulk silicon or silicon, affecting the integrity of silicon-gate dielectric interface due to spiking. Therefore, conventional copper interconnect technology requires the integration of several other layers (e.g. barrier, cap and seed). On the other hand, pre-deposition of catalyst is typically obtained by sputtering deposition of a seed layer, or by activating in a tin-palladium or tin-free PdCl₂ aqueous solution, thereby forming disjointed catalytic sites on the surface to be metalized. Sputtering deposition cannot form the required thin (few nm) continuous seed layer onto sub-45-nm trenches/holes due to cosine distribution and line-o-sight of the sputtered flux. The Pd particles during activation process tend to agglomerate into clusters with limited seed densities and sizes typically from tens to hundreds of nm.

### SUMMARY OF THE INVENTION

The objective of the present invention is to provide the SAMs grafted seeding and electroless deposition processing steps to selectively fabricate the patterns of metal-alloy thin films on dielectric layers with a minimum thickness of 10 nm (or less). The process technique of this invention consists of the steps of (1) organosilane species (e.g., Octadecyltrichlorosilane (OTS) treatment of the surface of the original dielectric substrate (e.g., Si (100) wafers with 500-nm-thick oxidized layer or CVD-Black Diamond™ etc.); (2) covering the treated substrate by a template (e.g., TEM grid); (3) vacuum plasma (N₂—H₂) treatment of the uncovered treated surface of the substrate; (4) immersing the substrate into an aqueous solution (e.g., SC-1); (5) immersing the substrate into an aqueous solution of metal salt (e.g. CuSO₄) wherein having the metal ions adsorbed onto the surface of the substrate; (6) reducing the adsorbed metal ions on the surface of the substrate: (7) electroless deposition of metal films. The plasma source of N₂—H₂ is environmentally friendly, less toxic and irritating, as opposed to the chlorofluorocarbon compounds (CFC) gases as dry etchant that pose a potential public hazard. The seeds produced by the present invention can be as small as 3 nm in size and immobilized to give an extremely high density of 5×10¹⁵ m⁻², whose features are superior to those obtained from previous conventional activation methods. Furthermore, the nanostructure produced is a precise replica of the template with high resolution.

### BRIEF DESCRIPTION OF THE DRAWINGS

FIG. 1 depicts the chemical reaction between OTS and hydrophilic dielectric substrate, which then produces hydrophobic OTS-SAM surface of substrate.

FIG. 2 is a flowchart illustrating steps for site-selective catalytic seeding and electroless deposition processes according to the present invention, which consists of dual surface modification by localized vacuum plasma and basic aqueous solution, cationic seed adsorption and reduction, and selective electroless metallization.

FIG. 3 shows the evolution of water contact angle for the dielectric samples after immersion in OTS-containing toluene solution for various durations.

FIG. 4 shows a set of carbon K-edge spectra recorded from OTS-SAM coated substrate before (a1) and after N₂—H₂ plasma treatment for 0.5 s (a2) and 2.0 s (a3). The normalized spectra for (a2) and (a3) after subtracting (a1) were shown in (b) and (c), respectively. The dashed line represents the zero level of difference.

FIG. 5 shows the scanning electron microscope (SEM) images of plasma pretreated and counterpart regions of substrate after seeding and electroless deposition steps shown in FIG. 2. Numerous tiny particles were present on the pretreated region, while scant amounts of particles could be found on the untreated region (pristine OTS-SAM).

FIG. 6 shows SEM images of highly distinguished Cu metallization pattern using the processing steps shown in FIG. 2.

FIG. 7 shows TEM images of an ultrathin (˜8 nm) Co—P barrier layer, which in turn catalyzed the growth of a Cu metallization film.

### DETAIL DESCRIPTIONS OF THE INVENTION PREFERRED EMBODIMENTS

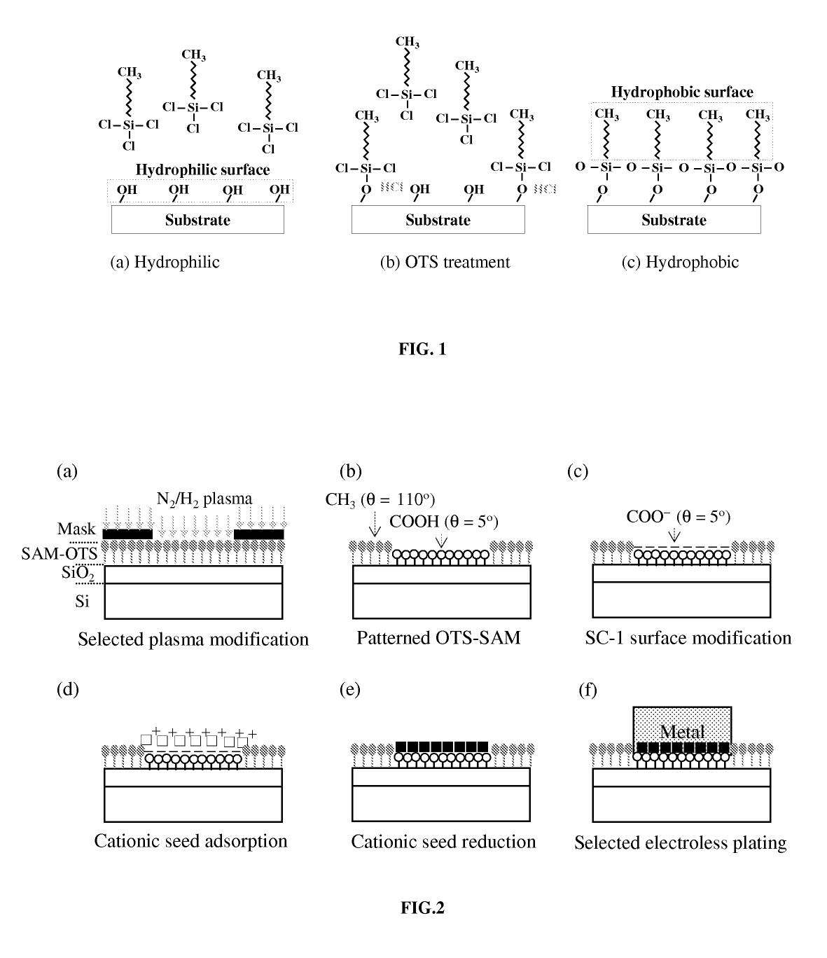

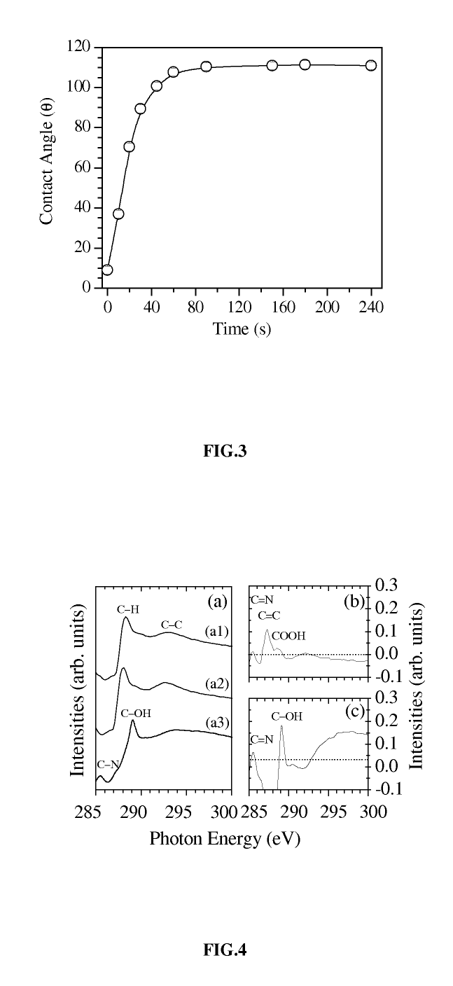

Referring to FIG. 1 in combination with FIG. 2, there is shown a nanostructured metallization patterns deposited on dielectric substrate via the integration of dual surface modification, aqueous seeding and electroless plating processes in accordance with the present invention in which the principles of SAM preparation, plasma treatment and electroless-plating deposition are utilized. The SAMs are prepared through the organic species-SAM grafting treatment. Taking the OTS as examples, as shown in FIG. 1, the side chains of these species are generally silane or alkyl hydrophobic bonds such as CH₃ and the surface of hydrophilic substrates is terminated by hydrophilic bonds such as —OH, this treatment therefore renders the initially hydrophilic substrate surface to be terminated by hydrophobic bonds, eventually becoming hydrophobic. Deposition of OTS-SAMs on the substrate was monitored by measuring the static contact angle of water droplets on the dielectric layers which were treated by OTS-containing toluene solution at various times, as shown in FIG. 3. The substrate layers, after thorough cleaning by aqueous solution and deionized water, were terminated by hydroxyl groups and thus became hydrophilic with a water contact angle of 10° at time 0. Upon adsorption onto the OH-terminated surfaces, the OTS molecules were tethered to the dielectric layers by a hydrolysis-condensation mechanism. Therefore, the water contact angle gradually increased with treatment time due to the accumulation of the non-polar methyl (CH₃) groups. At each point (time), the contact angle was measured five times on different parts of the samples with a maximum standard deviation of 2° with respect to the mean value. A monolayer was finally formed after treatment for 180 s with a saturated contact angle of 110°.

After the formation of organic species-SAM on the surface of dielectric substrate, the processes begin with step (a) and (b) in FIG. 2; covering the surface of SAM coated dielectric substrate with a template, allowing the uncovered regions to be functionalized by exposure to the vacuum plasma and thus introduce hydrophilic functional groups on the topmost region of the SAMs. Here in this invention, a copper TEM grid (400 mesh, square type) was used as an example. Impact of the plasma treatment on the surface bonding structure was characterized by near-edge X-ray absorption fine structure (NEXAFS) spectroscopy of K-edges. FIG. 4 displays a set of carbon K-edge spectra recorded from OTS-SAM coated substrate before (a1) and after N₂—H₂ plasma treatment for 0.5 s (a2) and 2.0 s (a3). Spectrum (a1) reveals that, before the plasma treatment, the substrate coated with hydrophobic OTS-SAM exhibited a sharp peak at 288.1 eV and a broad peak at 292.8 eV, in respective agreement with assignments of the resonance transitions from its constituent C—H and C—C bonds. While it is difficult to discern the detailed changes of the edge structures from the as-recorded spectra in FIG. 4(a), evolution of the associated surface bonding structures by the plasma exposure was revealed by subtracting the normalized spectrum of (a1) from spectra (a2) or (a3), as displayed in FIGS. 4(b) and 4(c), respectively. FIG. 4(b) shows that brief treatment for 0.5 s induced C═C (287.0 eV) and C═N (285.5 eV) peaks, interpreted as an entanglement/breakdown of the well-ordered alkyl chains and nitrogen functionalization of the OTS. An additional peak centered at 288.7 eV appeared, attributed to the formation of O═C—OH (carboxyl) polar groups conceivably by the chemical interaction between the cracked hydrocarbon and the plasma activated oxygen-based species residing in the vacuum chamber. FIG. 4(c) reveals that treating for 2 s resulted in an expected further nitrogen functionalization of the C═N bonds, corresponding to the emergence of the N K-edge at 401.0 eV (spectrum not shown). An unexpected introduction of the prominent C—OH groups (289.1 eV), accompanied by the vanishing of the O═C—OH groups, onto the topmost surface region was also observed. Prolonged exposure for 10 s led to a complete ablation of the OTS-SAM. Thus, NEXAFS analysis as a function of the plasma treatment time confirms that the N₂—H₂ plasma treatments of the OTS films lead to a progressive nitridation (i.e., C═N formation) and the successive conversion of the dissociated hydrocarbon within the aliphatic chains (C—C, C—H and C═C) to double-bonded O═C—OH groups and finally single-bonded (C—OH) polar functional groups.

In steps(c), select an aqueous solution (e.g., SC-1 (NH₄OH:H₂O₂:H₂O)=1:1:5)) with appropriate PH value and immerse the dielectric substrate into the solution. The aqueous solution was applied in an attempt to tailor the hydrophilic functional groups of the plasma-exposed regions to negatively charged sites.

In step (d), immerse the negatively charged dielectric surface into an aqueous metal-salt solution (e.g. Co(NO₃)₂ or Ni(CO₃)₂). Upon immersion, the negatively charged sites provided points to attract metallic cations in the confined regions. Consequently, ultrafine nanoparticles of atomic scaled metal ions are adsorbed on the surface of the substrate.

In step (e), completely reduce the attracted metallic cations into neutral metal particles by a reducing agent. This step provides the catalytic effect for the subsequent electroless deposition process. The catalytic particles acted as a template for site-selective electroless deposition of metallization films (e.g., Cu or Co-based), as shown in step (f). After processed by steps (d) and (e) for seeding, SEM imaging analysis showed that X-ray signals of the metallic (e.g., Co or Ni) seeds were obviously detected from the plasma-exposed regions, whereas the signals were obscure in the grid-covered regions (spectra not shown here). This difference indicates site-selective adsorption of seeds. Concurrently, SEM images in FIG. 5 confirm that, after electroless deposition of Cu for 8 s by step (f) of FIG. 2, many tiny particles existed on the plasma-exposed regions (FIG. 5(a)), but the number of particles was scant on the grid-masked regions (FIG. 5(b)). Notably, as estimated from FIG. 5, the seed density for the plasma-exposed region is on an order of 10¹⁵ m⁻², whereas that for the covered region is only 6×10¹¹ m⁻². Therefore, the site-controlled seeding process yields a seed-adsorption selectivity of greater than 1000:1. FIG. 5 demonstrates that, after the sequential treatments by aqueous solutions following the steps (c) to (e) in FIG. 2, both the plasma-induced COOH and C—OH terminated alkyl chains can effectively bind the catalytic species.

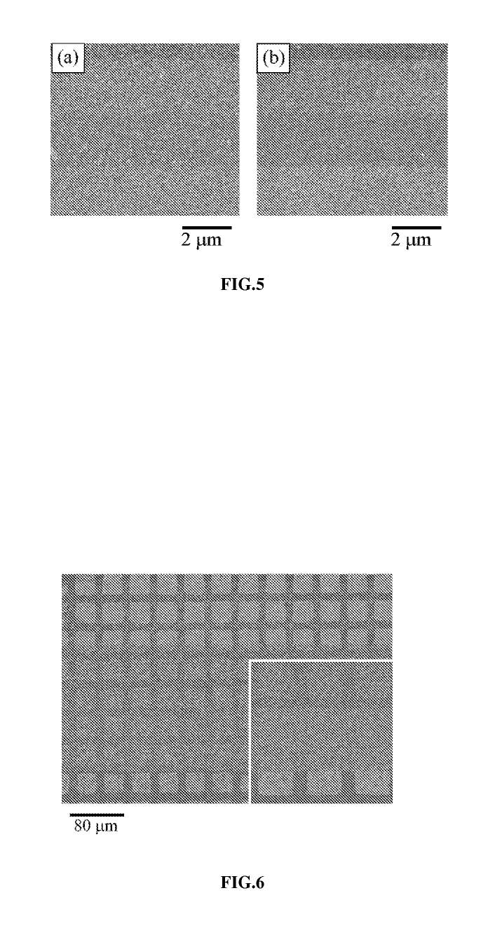

As is generally known, protons in hydroxyl groups are detached by an aqueous solution with pH values greater than the pH value of its isoelectric point (pHᵢₑₚ) or its pKₐ. The values of pHᵢₑₚ and pKₐ for carboxylic groups are typically less than 4. Therefore, during the treatment of the basic aqueous solution in step (c) in FIG. 2, protons in the COOH functional groups of the plasma-exposed regions indeed are liberated into the solution, and thus the associated surfaces become negatively charged and water wetted (θ=5°) by COO⁻ groups. Conversely, the regions of the monolayer, protected by the grids from the plasma exposure, lack wetting (θ=110°) and remain neutral in charge due to the presence of the non-polar CH₃ headgroups. Upon immersion in an aqueous solution of metal salt (e.g., Co(NO₃)₂) by step (d) of FIG. 2, the hydrated metallic cations were attracted onto the negatively charged (COO⁻) regions by electrostatic force. In contrast, the adsorption of the metallic cations was prohibited in the OTS-covered regions due to the lack of wetting and mutual electrostatic interaction. Subsequently, after the reduction treatment by step (e) of FIG. 2, the catalytic particles were reduced into neutral form and preferentially adsorbed onto the plasma modified OTS-SAM regions (compare FIGS. 5(a) and 5(b)). By soaking the seed-bearing dielectric samples in an ultrasonic cleaner, the seeds weakly residing on the OTS-covered regions were completely removed, while those on the plasma-exposed regions remained intact. As demonstrated in FIG. 6, the seeds on the micro-patterned substrates thus act as a template for the site-selective fabrication of highly resolved Cu metallization patterns using process step (f) of FIG. 2. It is evident from the inset in FIG. 6 that, for the OTS monolayers patterned by the optimum plasma condition, the metallization pattern was a replica of the grid mask, with the square width (30 μm) and line width (10 μm) essentially identical to the featured sizes of the grids. This sameness implies that the penetration of the plasma-activated radicals and photon radiation into the areas shielded by the grids occurs to a negligible extent.

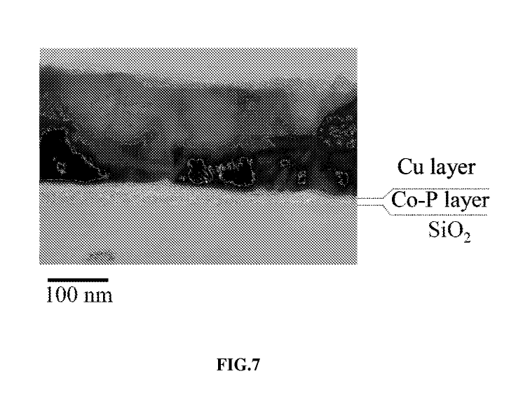

It is not uncommon for site-selective electroless metallization for a variety of nonconductive substrates with the aid of catalytic particles such as Pd, Au, and Cu. Since metallization is confined to the specific surface regions bearing the plating catalysts, the accuracy of site-selective adsorption and the precise controls over the size and distribution density of the colloidal catalysts are vital factors to achieving highly resolved metallization patterns with a film thickness of, for example, 10 nm. However, the activation/sensitization process involves the use of costly PdCl₂ and numerous complex additives. When conducted in a conventional manner at a Pd—Sn colloidal solution, this process, on the one hand, generates catalytic particles with sizes less than 5 nm but with extremely inhomogeneous distribution, and on the other hand, it lacks control over the size and morphology of Pd colloids, thus resulting in (a) an agglomeration of the particle sizes up to 10 nm and (b) a limit of particle densities on an order of 10¹³ m⁻². Notably, the site-selective seeding process presented herein does not incur the demerits of the Pd materials and related aqueous chemistry and can grow tiny catalytic particles other than Pd, such as Cu, Co, or Ni. As evidenced from FIG. 5(a), the metallic cations were effectively adsorbed by and anchored to the plasma activated sites without agglomeration. As demonstrated in FIG. 7, the seeds with these refining features have the capacity to serve as a template for electroless deposition of a barrier layer with a thickness of less than 10 nm (using Co—P as a test), a barrier which in turn acts as a catalyst for the electroless metallization of Cu.

While the present invention disclosed herein has been described by means of specific embodiments, numerous modifications and variations could be made thereto by those skilled in the art without departing from the scope and spirit of the present invention set forth in the claims.

1. Processes for nanostructured metallization patterns on a dielectric substrate, comprising the steps of:
(a) Covering the SAM-coated surface of dielectric substrate with a template; treating the covered surface by vacuum plasma;
(b) introducing hydrophilic surface on plasma-exposed (uncovered) regions and hydrophobic surface on untreated (covered) regions of the SAM-coated surface of dielectric substrate;
(c) immersing the substrate into an aqueous solution; removing the hydrogen from the surface of the substrate;
(d) immersing the negatively charged dielectric surface into an aqueous metal salt solution for adsorbing metal ions;
(e) immersing the substrate with adsorbed metal ions into an aqueous solution to reduce the positively charged metal ions into neutral metal particles;
(f) immersing the dielectric substrate into an electroless-plating solution for deposition of metal and metal-alloy patterns.

2. The process of claim 1, the dielectric material is selected from HOSP™, CVD-Black Diamond™, silicate glass, silicon dioxide or polysiloxanes etc., which can form an active surface on the substrate to be readily modified by step (a)-(h).

3. The process of claim 1, wherein the self-assembled-monolayer organosilane species grafted surface undergoes step (a)-(c) to form a hydrophilic surface, plasma is formed of ionized gas of N₂—H₂, and the basic aqueous solution is an alkali solution including strong oxidizing ability.
